(19) United States
(12) Patent Application Publication
(10) Pub. No.: US 2026/0316327 A1
(43) Pub. Date: Oct. 15, 2026

(54) EQUIPMENT FOR RESINATING WOODEN MATERIAL

(71) Applicant: IMAL S.r.l., Modena (MO) (IT)

(72) Inventor: Paolo BENEDETTI, Modena (MO) (IT)

(73) Assignee: IMAL S.r.l., Modena (MO) (IT)

(21) Appl. No.: 19/646,693

(22) Filed: Apr. 14, 2026

(30) Foreign Application Priority Data
Apr. 14, 2025 (IT) 102025000008271

(51) Int. Cl. B27N 1/02

(52) U.S. Cl. CPC B27N 1/0245

(57) ABSTRACT

Equipment including one mixing chamber provided with one inlet port of a wooden material and one outlet port of the wooden material admixed with the binding agent; one resinating chamber; a mixing device arranged internally to said resinating chamber and including one shaft and one spiral body. The resinating chamber includes a first stretch including a first bottom wall arranged facing the outlet port; a second stretch located downstream of the first stretch and including a second bottom wall; and a third stretch located downstream of the second stretch with respect to the direction of forward movement and comprising a third bottom wall. The distance between the shaft and the first bottom wall is less than the distance between the shaft and the second bottom wall. The distance between the shaft and the third bottom wall is greater than the distance between the shaft and the second bottom wall.

### TECHNICAL FIELD

The present invention relates to a piece of equipment for resinating wooden material.

### BACKGROUND ART

In the woodworking industry, it is common to produce wooden panels by compacting loose, fibrous wooden materials, admixed with a binding agent.

This particular manufacturing process yields, for example, particleboard, medium-density fiberboard (MDF), and low-density fiberboard (LDF).

Prior to the aforementioned compaction phase, a resinating process of the wooden material is carried out, which involves mixing a base wooden material with a binding agent.

The resinating process is carried out using equipment that generally comprises:
feeding means of a wooden material to be machined, consisting of wood fibers and/or flakes;
a mixing assembly that receives the wooden material to be machined from the feeding means and adds one or more binding agents to this material;
a resinating assembly that receives the wooden material admixed with the binding agent from the mixing assembly and mixes these components to obtain a wooden material to be compacted, having a paste-like texture, to be conveyed to the subsequent compaction phase.

The mixing assembly typically comprises a mixing hopper, provided with an inlet port connected downstream of the feeding means and an outlet port connected upstream of the resinating assembly.

Furthermore, the mixing assembly comprises dispensing means for dispensing the binding agent, positioned at the inlet port of the mixing hopper and operable to spread the binding agent over the base material present within the mixing hopper.

The resinating assembly also comprises a resinating chamber placed below the mixing hopper, which receives the wooden material admixed with the binding agent from the mixing hopper.

The resinating assembly comprises a screw conveyor arranged within the resinating chamber and operable to mix the material received from the mixing hopper and to make the resulting mixture move forward toward an outlet provided in the resinating chamber itself.

The use of resinating equipment of known type does, however, have certain drawbacks that are primarily due to the type of binding agent used, which has a very high adhesive strength and which, once dried, is difficult to remove from the surfaces on which it settles.

Since the binding agent is sprayed inside the mixing hopper, a portion thereof does not intercept the base wooden material and therefore falls back into the resinating chamber below.

More specifically, the binding agent settles on the portion of the screw conveyor shaft located within the resinating chamber and facing the outlet port of the mixing chamber.

It is apparent that the presence of encrustations and/or settlements of binding agent on the rotational shaft can impede the rotation thereof, thus impairing the operation of the screw conveyor, which may slow down to the point of jamming.

This necessitates the rapid and frequent removal of binding agent settlements from the rotational shaft, leading to the screw conveyor jamming and the consequent downtime of the entire production process.

To try to overcome these drawbacks, a conveyor belt is sometimes positioned between the outlet port of the mixing hopper and the resinating chamber, intended to directly receive the wooden material and binding agent coming out of the mixing hopper.

In fact, this particular design choice does not fix the problem described above; indeed, the binding agent settles and dries on the conveyor belt, which must still be cleaned to operate properly, thereby still causing the equipment and the entire production process to shut down.

### DESCRIPTION OF THE INVENTION

The main aim of the present invention is to devise a piece of equipment for resinating wooden material that allows for the avoidance, or at least the reduction, of machine downtime caused by maintenance operations aimed at cleaning the screw conveyor shaft of the binding agent that has accumulated thereon over time.

Within this aim, one object of the present invention is therefore to improve the performance of the resinating equipment and to reduce maintenance costs.

Another object of the present invention is to devise a piece of equipment for resinating wooden material that allows the aforementioned drawbacks of the prior art to be overcome through a simple, rational, easy and effective to use, as well as affordable solution.

The aforementioned objects are achieved by the present piece of equipment for resinating wooden material having the characteristics of claim 1.

### BRIEF DESCRIPTION OF THE DRAWINGS

Further characteristics and advantages of the present invention will become more apparent from the description of a preferred, but not exclusive, embodiment of a piece of equipment for resinating wooden material, illustrated by way of an indicative, yet non-limiting example, in the attached drawings, wherein:

FIG. 1 is a schematic front view of a piece of equipment for resinating wooden material according to the invention;

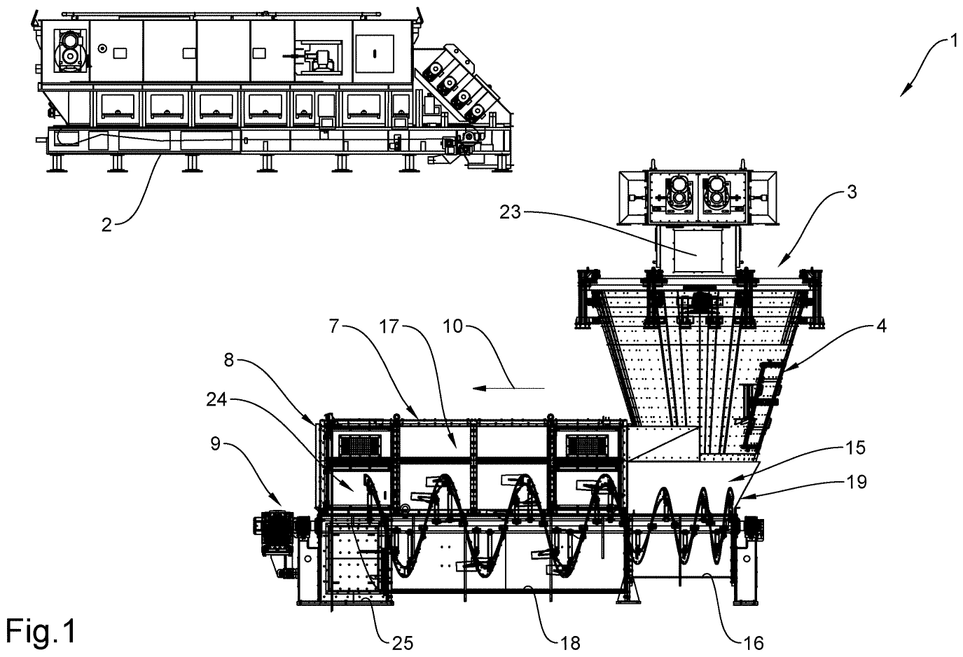

FIG. 2 is a sectional view of some components of the equipment according to the invention.

### EMBODIMENTS OF THE INVENTION

With particular reference to these figures, reference numeral 1 globally indicates a piece of equipment for resinating wooden material.

The piece of equipment 1 comprises:
feeding means 2 of a base material comprising flakes and/or fibers made of wooden material;
at least one mixing assembly 3 comprising at least one mixing chamber 4, provided with at least one inlet port 5 of the base material fed by the feeding means 2, dispensing means 23 of at least one binding agent within the mixing chamber 4, so as to admix the base material with the binding agent, and with at least one outlet port 6 of the base material admixed with the binding agent;
at least one resinating assembly 7 arranged below the mixing assembly 3 and comprising at least one resinating chamber 8, adapted to receive the base material admixed with the binding agent coming out of the outlet port 6, and a mixing device 9, arranged internally to the resinating chamber 8 and adapted to mechanically mix the base material with the binding agent to obtain a homogeneous mixture;
   wherein the mixing device 9 is adapted to move the homogeneous mixture along a direction of forward movement 10 and comprises at least one shaft 11, rotatable around a relevant axis, and at least one spiral body 12, 13, developing around the shaft 11.

In other words, the spiral body 12, 13 comprises coils that develop around the shaft 11.

In actual facts, the mixing device 9 is of the mixing screw conveyor type.

With reference to the possible embodiment shown in the figures, the feeding means 2 comprise a conveyor belt provided with an inlet zone, at which the base material is loaded, and with an outlet zone at which the base material is released and sent to the mixing assembly 3.

More specifically, the feeding means 2 are adapted to move the base material along a feeding direction extending between the inlet zone and the outlet zone.

Preferably, the feeding means 2 are positioned on top of the inlet port 5, and the base material is transferred to the mixing chamber 4 by gravity.

Usefully, the feeding means 2 comprise at least one weighing device associated below the conveyor belt and adapted to measure the weight of the base material moved by the same conveyor belt.

The amount of binding agent which is dispensed by the mixing assembly 3 into the mixing chamber 4 is related to the weight of the base material detected by the weighing device.

Preferably, the mixing chamber 4 has a substantially tapered shape and is converging from the inlet port 5 toward the outlet port 6.

In other words, the mixing chamber 4 is of the type of a hopper.

This particular geometric shape of the mixing chamber 4 promotes the conveyance of the base material admixed with the binding agent toward the outlet port 6, thereby promoting the outcome thereof and the subsequent transfer to the resinating assembly 7.

The dispensing means 23 of the binding agent are arranged along the perimeter edge of the mixing chamber 4 and are adapted to atomize the binding agent in such a way as to increase the dispersion thereof within the mixing chamber itself and, therefore, the likelihood of adhesion to the base material.

The resinating chamber 8 comprises an inlet portion, intended to receive the base material admixed with the binding agent coming from the mixing chamber 4, and an outlet portion, adapted to allow the homogeneous mixture to come out of the same resinating chamber 8.

The direction of forward movement 10 defined by the mixing device 9 extends between the inlet portion and the outlet portion.

The resinating chamber 8 has a substantially elongated shape along the direction of forward movement 10.

The shaft 11 is substantially parallel to the direction of forward movement 10.

Accordingly, the mixing device 9 comprises motor means 14 associated with the shaft 11 and adapted to move the latter in rotation around its own axis.

As a result of the rotational drive of the shaft 11, the spiral body 12, 13, which rotates locked together with the shaft itself, moves the set consisting of the base material and the binding agent in a helical motion, making the resulting compound move forward along the direction of forward movement 10.

According to the invention, the resinating chamber 8 comprises:
at least a first stretch 15 comprising at least a first bottom wall 16 arranged facing the outlet port 6;
at least a second stretch 17 located downstream of the first stretch 15 with respect to the direction of forward movement 10 and comprising at least a second bottom wall 18;
at least a third stretch 24 located downstream of the second stretch 17 with respect to the direction of forward movement 10 and comprising at least a third bottom wall 25;
   wherein the distance between the shaft 11 and the first bottom wall 16 is less than the distance between the shaft 11 and the second bottom wall 18, and wherein the distance between the shaft 11 and the third bottom wall 25 is greater than the distance between the shaft 11 and the second bottom wall 18.

More specifically, the distance between the shaft 11 and the bottom walls 16, 18, 25 is measured starting from the axis of rotation of the shaft itself.

The resinating chamber 8 thus has three bottom walls 16, 18, 25, the distance of which from the shaft 11 increases progressively as one moves forward along the direction of forward movement 10.

Preferably, the first stretch 15 is open at the top so as to be directly communicating with the mixing chamber 4.

The first stretch 15 is therefore located at the inlet portion of the resinating chamber 8, and the third stretch 24 is located at the outlet portion.

In other words, the third stretch 24 is provided with an opening for discharging the mixture to the outside, which is not shown in detail in the figures.

Conveniently, the first stretch 15 and the second stretch 17 are set in seamless communication to each other. In other words, the area between the first stretch 15 and the second stretch 17 is free of barriers or interruptions. The passageway between the first stretch 15 and the second stretch 17 is therefore open.

Similarly, the second stretch 17 and the third stretch 24 are also seamlessly communicating to each other.

Advantageously, the ends of the spiral body 12, 13 are spaced apart from the inner walls of the resinating chamber 8. In other words, the ends of the coils are spaced apart from both the respective bottom walls 16, 18 and the top walls opposite the bottom walls.

Advantageously, the resinating assembly 7 comprises at least one conveying body 19 placed between the outlet port 6 and the first stretch 15 and adapted to direct the base material admixed with the binding agent out of the mixing chamber 4 toward the first stretch 15.

Advantageously, the conveying body 19 comprises at least one conveying wall 20 that is oblique with respect to the direction of forward movement 10 and converging toward the second stretch 17.

The base material admixed with the binding agent enters the resinating chamber 8 through the relevant inlet portion and settles on the first bottom wall 16, progressively filling the first stretch 15 and covering the shaft 11.

The fact of positioning the shaft 11 at a distance from the first bottom wall 16 that is shorter than the distance from the second bottom wall 18 causes the amount of material needed to cover the shaft 11 to be less in the first stretch 15 than in the second stretch 17. In other words, the shorter distance between the shaft 11 and the first bottom wall 16 with respect to the second bottom wall 18 causes the material coming from the mixing chamber 4 to quickly cover the shaft 11, thus coating it.

The material that covers the shaft 11 at the first stretch 15 thus allows preventing the portion thereof facing the outlet port 6 from being exposed to the falling of the binding agent, which is thereby settled directly onto the base material rather than onto the shaft 11.

In other words, the piece of equipment 1 according to the invention causes the material coming from the mixing chamber 4 to accumulate rapidly on the first bottom wall 16, thus coating the portion of the shaft 11 facing the outlet port 6.

Advantageously, the spiral body 12, 13 comprises at least a first portion 12, arranged at the first stretch 15 and having a first diameter, and at least a second portion 13, arranged at the second stretch 17 and having a second diameter greater than the first diameter.

Preferably, the shaft 11 is made in a single body piece.

In other words, the first portion 12 and the second portion 13 are mounted on the same rotational shaft 11.

More specifically, the first portion 12 and the second portion 13 are seamlessly connected to each other. In other words, the coils of the first portion 12 join the coils of the second portion 13 without interruption, that is, seamlessly.

Advantageously, the portion of the shaft 11 arranged at the third stretch 24 and facing the third bottom wall 25 has no coils.

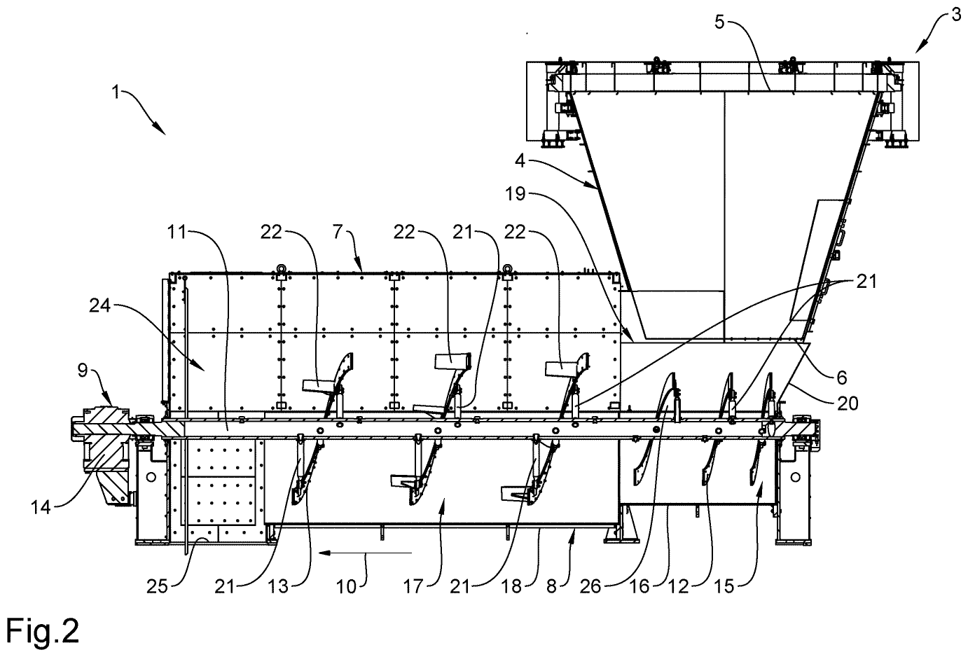

Conveniently, as shown in FIG. 2, the portion of the shaft 11 facing the third bottom wall 25 is substantially smooth.

The coils of the spiral body 12, 13 therefore end up at the second portion 13.

More specifically, the spiral body 12, 13 defines a pair of faces, identified by reference numerals 12a, 12b, 13a, 13b, which are opposite to each other and adapted to interact with the mixture.

Accordingly, the first portion 12 defines a first face 12a and a second face 12b which are opposite each other, and the second portion 13 defines a first face 13a and a second face 13b which are opposite each other. The first faces 12a and 13a are the faces interacting with the mixture to move it along the direction of forward movement 10. In other words, the first faces 12a and 13a face the outlet portion of the resinating chamber 8. The first faces 12a, 13a are therefore the “front” faces of the spiral body 12, 13, and the second faces 12b, 13b are the “rear” faces of the spiral body 12, 13.

Usefully, the mixing device 9 comprises connecting means 21 for connecting the spiral body 12, 13 to the shaft 11.

More specifically, the connecting means 21 are shaped in such a way that they support the spiral body 12,13 and define, between the spiral body itself and the shaft 11, a transit area 26 of the base material admixed with the binding agent.

The transit area 26 is thus located between the shaft 11 and the inner profile of the spiral body 12, 13.

More specifically, the transit area 26 has a substantially toroidal shape (i.e., excluding the presence of the connecting means 21).

As shown in the figures, the connecting means 21 have one end associated with the shaft 11 and the opposite end associated with one of the faces 12a, 12b, 13a, 13b of the spiral body 12, 13.

Preferably, the connecting means 21 are associated with the second face 12b, 13b of the corresponding portion 12, 13 of the spiral body 12, 13.

This particular technical expedient allows promoting the forward movement of the base material admixed with the binding agent within the resinating chamber 8.

With reference to the possible embodiment shown in the figures, the connecting means 21 comprise a plurality of connecting bodies 21, located between the shaft 11 and the spiral body 12, 13, having a substantially elongated shape and developing substantially orthogonal to the axis of the shaft itself.

Usefully, the mixing device 9 comprises auxiliary mixing means 22 of the base material with the binding agent, associated with the spiral body 12, 13.

Preferably, the auxiliary mixing means 22 comprise a plurality of paddle bodies 22 distributed on the spiral body 12, 13, arranged transversely to the latter and substantially parallel to the direction of forward movement 10.

With reference to the possible embodiment shown in the figures, the paddle bodies 22 are associated with the second portion 13.

Conveniently, the paddle bodies 22 are associated with the first face 13a of the second portion 13.

The presence of the paddle bodies 22 promotes the mixing of the base material with the binding agent, thereby obtaining a homogeneous mixture as it comes out of the resinating chamber 8.

It has in practice been ascertained that the described invention achieves the intended objects, and in particular, the fact is emphasized that the specific geometric configuration of the resinating chamber allows the shaft of the mixing device to be easily coated with the material coming from the mixing chamber, thereby minimizing the amount of binding agent that settles thereon.

In this way, the equipment according to the invention makes it possible to reduce the frequency of the cleaning and maintenance operations required for the resinating assembly, particularly for the rotational shaft of the relevant screw conveyor, thereby minimizing the machine downtime through a simple and affordable solution.

1) An equipment for resinating wooden material, said equipment comprising: yp2 feeding means of a base material comprising at least flakes and/or fibers made of wooden material;
at least one mixing assembly comprising at least one mixing chamber, provided with at least one inlet port of the base material fed by said feeding means, dispensing means of at least one binding agent within said mixing chamber, to admix the base material with the binding agent, and at least one outlet port of the base material admixed with the binding agent; and
at least one resinating assembly arranged below said mixing assembly and comprising at least one resinating chamber, adapted to receive the base material admixed with the binding agent coming out of said outlet port, and a mixing device, arranged internally to said resinating chamber and adapted to mechanically mix the base material with the binding agent to obtain a homogeneous mixture, wherein
said mixing device is adapted to move the homogeneous mixture along a direction of forward movement and comprises at least one shaft, rotatable around a relevant axis, and at least one spiral body, developing around said shaft;
said resinating chamber (8) comprises:
at least a first stretch comprising at least a first bottom wall arranged facing said outlet port;
at least a second stretch located downstream of said first stretch with respect to said direction of forward movement and comprising at least a second bottom wall; and
at least a third stretch located downstream of said second stretch with respect to said direction of forward movement and comprising at least a third bottom wall;
the distance between said shaft and said first bottom wall is less than the distance between said shaft and said second bottom wall, and
the distance between said shaft and said third bottom wall is greater than the distance between said shaft and said second bottom wall.

2) The equipment according to claim 1, wherein said spiral body comprises at least a first portion, arranged at said first stretch and having a first diameter, and at least a second portion, arranged at said second stretch and having a second diameter greater than said first diameter.

3) The equipment according to claim 2, wherein said first portion and said second portion are seamlessly connected to each other.

4) The equipment according to claim 1, wherein said first stretch and said second stretch are set in seamless communication with each other.

5) The equipment according to claim 1, wherein the portion of said shaft arranged at said third stretch and facing said third bottom wall has no coils.

6) The equipment according to claim 1, wherein said shaft is made in a single body piece.

7) The equipment according to claim 1, wherein said first stretch is open at the top to allow the direct introduction of the base material admixed with the binding agent within said resinating chamber.

8) The equipment according to claim 1, wherein said resinating assembly comprises at least one conveying body placed between said outlet port and said first stretch and adapted to direct the base material admixed with the binding agent coming out of said mixing chamber toward said first stretch.

9) The equipment according to claim 8, wherein said conveying body comprises at least one conveying wall oblique to said direction of forward movement and converging toward said second stretch.

10) The equipment according to claim 1, wherein
said spiral body defines a pair of faces which are opposite each other and adapted to interact with said mixture,
said mixing device comprises connecting means adapted to connect said spiral body to said rotational shaft, and
said connecting means have one end associated with said shaft and the opposite end associated with one of said faces, between said spiral body and said shaft being defined a transit area of the base material admixed with the binding agent.

11) The equipment according to claim 10, wherein
said faces comprise a first face adapted to interact with said mixture to push it along said direction of forward movement and a second face opposite the respective first face, and
said connecting means are associated with said second face.

12) The equipment according to claim 1, wherein said mixing device comprises auxiliary mixing means of the base material with the binding agent associated with said spiral body.

13) The equipment according to claim 1, wherein said auxiliary mixing means comprise a plurality of paddle bodies distributed on said spiral body, arranged transversely to the latter and substantially parallel to the direction of forward movement.

14) The equipment according to claim 1, wherein said paddle bodies are associated with said second portion.

15) The equipment according to claim 1, wherein said paddle bodies are associated with said first face of said second portion.
